(19) United States
(12) Patent Application Publication
(10) Pub. No.: US 2012/0034504 A1
(43) Pub. Date: Feb. 9, 2012

(54) FLAT SECONDARY BATTERY ELECTRODE GROUP, METHOD FOR MANUFACTURING SAME, AND FLAT SECONDARY BATTERY WITH FLAT SECONDARY BATTERY ELECTRODE GROUP

(76) Inventor: Mayumi Kaneda, Osaka (JP)

(21) Appl. No.: 13/263,927

(22) PCT Filed: Oct. 8, 2010
(86) PCT No.: PCT/JP2010/006041

§ 371 Date: Oct. 11, 2011

(30) Foreign Application Priority Data
Oct. 22, 2009 (JP) 2009-243005

(51) Int. Cl. H01M 4/00; H01M 10/00

(52) U.S. Cl. 429/94; 29/623.1

(57) ABSTRACT

Innermost parts (8A, 9A) of bent portions of an electrode group (1) are positioned opposite each other relative to a center line (6).

### TECHNICAL FIELD

The present invention relates to secondary batteries represented by lithium ion secondary batteries, particularly to an electrode group for a flat secondary battery (hereinafter referred to as a “flat electrode group”), a method for fabricating the same, and a flat secondary battery including the flat electrode group.

### BACKGROUND ART

In lithium ion secondary batteries which have widely been used as power sources of portable electronic devices, a carbon-based material capable of inserting and extracting lithium is used as a negative electrode active material, and composite oxide of transition metal and lithium (e.g., LiCoO₂, etc.) is used as a positive electrode active material. This provides the lithium ion secondary battery with high potential and high discharge capacity.

The lithium ion secondary battery is fabricated by the following method. First, a positive electrode and a negative electrode are wound into spiral shape with a separator (a porous insulator) interposed therebetween. The obtained electrode group, and a nonaqueous electrolytic solution are placed in a battery case made of stainless steel, nickel-plated iron, aluminum, etc. Then, an opening of the battery case is hermetically sealed with a sealing plate.

The electrode (the positive or negative electrode) is fabricated by the following method. A mixture of materials (an active material, a binder, and a conductive agent if necessary) in a slurry state is applied to a current collector, and is dried (fabrication of a base of the electrode). Then, the electrode base is compressed to a predetermined thickness by pressing etc. Increasing an amount of the active material applied to the current collector can increase a density of the active material in the electrode, thereby increasing a capacity of the lithium ion secondary battery.

Due to variety of functions and reduced size of the electronic devices and telecommunication devices, the lithium ion secondary batteries of smaller size, and higher capacity have been required. Particularly in the electronic devices and the telecommunication devices which are thinned down, a flat lithium ion secondary battery including power generation components (an electrode group etc.) placed in a battery case has been used to save space for the battery, or to correspond with the shape of the device in which the secondary battery is mounted.

For example, Patent Document 1 proposes a method for fabricating a flat electrode group. FIGS. 6(a)-6(b) are schematic cross-sectional views sequentially illustrating steps of a method for fabricating the flat electrode group of Patent Document 1.

First, a positive electrode, a negative electrode, and a porous insulator are wound around a cylindrical core (not shown) to fabricate a cylindrical electrode group 91. Then, as shown in FIG. 6(a), cylindrical jigs 93, 94 are inserted in a hollow part 92 of the electrode group 91, and the jigs 93, 94 are moved outward in a radial direction of the electrode group 91. This changes a lateral cross-section of the electrode group 91 from a substantially round shape to an elliptic shape as shown in FIG. 6(b). Then, the electrode group 91 is pressed to fabricate a flat electrode group (not shown).

### CITATION LIST

### Patent Document

[Patent Document 1] Japanese Patent Publication No. 2006-278184

### SUMMARY OF THE INVENTION

### Technical Problem

According to the method disclosed by Patent Document 1, parts of the electrode group 91 shown in FIG. 6(b) in contact with the jigs 93, 94 are positioned on a major axis of the electrode group 91. Thus, when the electrode group 91 is pressed, an electrode mixture layer may be cracked, or separated from a current collector at the parts of the electrode group 91 in contact with the jigs 93, 94 (hereinafter merely referred to as “separation of the electrode mixture layer”). This may reduce a capacity of the secondary battery.

Due to the cracking or separation of the electrode mixture layer, the electrode mixture layer may drop from the current collector (hereinafter merely referred to as “drop of the electrode mixture layer”). An internal short circuit may occur when the dropped electrode mixture layer penetrates the porous insulator.

In view of the foregoing, the present invention has been achieved. The present invention is concerned with providing a flat and highly safe secondary battery which can be fabricated without cracking or separation of the electrode mixture layer.

### Solution to the Problem

A flat electrode group according to the present invention is formed by winding a positive electrode and a negative electrode with a porous insulator interposed therebetween, and flattening the wound product by pressing. Bent portions are provided at ends of the electrode group in a direction of a long axis thereof, respectively, and parts of the bent portions at the innermost of the flat electrode group (hereinafter referred to as “innermost parts of the bent portions”) are positioned opposite each other relative to a center line which passes a midpoint of the electrode group in a direction of a thickness thereof, and extends in the direction of the long axis. The innermost parts of the bent portions may be symmetric about a point on the center line. The “center line” is, e.g., a major axis of the flat electrode group. The “point on the center line” is, e.g., a point of intersection of a major axis and a minor axis of the flat electrode group (the minor axis is a line extending in a direction of a short axis of the flat electrode group), or the center of a lateral cross-section of the flat electrode group.

The flat electrode group can be fabricated without cracking or separation of the electrode mixture layer, and can provide the flat secondary battery with high safety.

The flat electrode group of the present invention is fabricated by the following method. First, the positive electrode and the negative electrode are wound with the porous insulator interposed therebetween to form an intermediate electrode group having a parallelogram-shaped lateral cross-section. Then, the intermediate electrode group is pressed to form a flat electrode group. Through the pressing, bent portions are formed at ends of the flat electrode group in a direction of a long axis thereof, respectively, and innermost parts of the bent portions are positioned opposite each other relative to the center line.

The intermediate electrode group may be pressed with a spacer having curved portions at longitudinal ends thereof inserted in a hollow part of the intermediate electrode group. This can ensure the size of the hollow part. Thus, increase in volume of the electrode group through charge/discharge can easily be absorbed by the hollow part. This can reduce expansion of the battery due to expansion of the electrode, and can prevent the occurrence of an internal short circuit etc. due to the expansion of the battery.

In the present description, the “parallelogram” may include a shape which is slightly deformed from a perfect parallelogram. Being “symmetric about a point” may include a positional relationship which is slightly deviated from perfect point symmetry. The “midpoint” may include a position which is slightly misaligned from a perfect midpoint. Unless otherwise deviated from the scope of the advantages of the present invention, modifications may be made to the flat electrode group, the intermediate electrode group, the hollow part of the intermediate electrode group, the shape of the core, the positions of the innermost parts of the bent portions, etc.

In the present description, the expression that two parts are symmetric about a particular point designates that the two parts are not positioned on a major axis of the flat electrode group, the intermediate electrode group, or the core, and are positioned symmetric about the particular point.

### Advantages of the Invention

According to the present invention, the flat electrode group can be fabricated without cracking or separation of the electrode mixture layer. Thus, the present invention can provide the flat secondary battery with high safety.

### BRIEF DESCRIPTION OF THE DRAWINGS

FIGS. 1(a)-1(c) are schematic cross-sectional views illustrating a flat electrode group of the present invention.

FIGS. 2(a)-2(d) are schematic cross-sectional views sequentially illustrating steps of a method for fabricating the flat electrode group of the present invention.

FIGS. 3(a)-3(b) are schematic cross-sectional views sequentially illustrating steps of another method for fabricating the flat electrode group of the present invention.

FIG. 4 is a perspective view, partially cut away, of a flat secondary battery of the present invention.

FIGS. 5(a)-5(c) are schematic cross-sectional views sequentially illustrating steps of a method for fabricating a flat electrode group according to a comparative example.

FIGS. 6(a)-6(b) are schematic cross-sectional views sequentially illustrating steps of a method for fabricating a conventional flat electrode group.

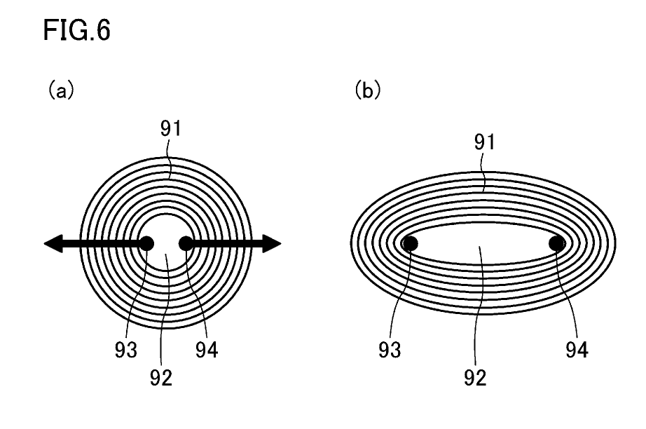

### DESCRIPTION OF EMBODIMENTS

An embodiment of the present invention will be described below with reference to the drawings. The present invention is not limited to the following embodiment.

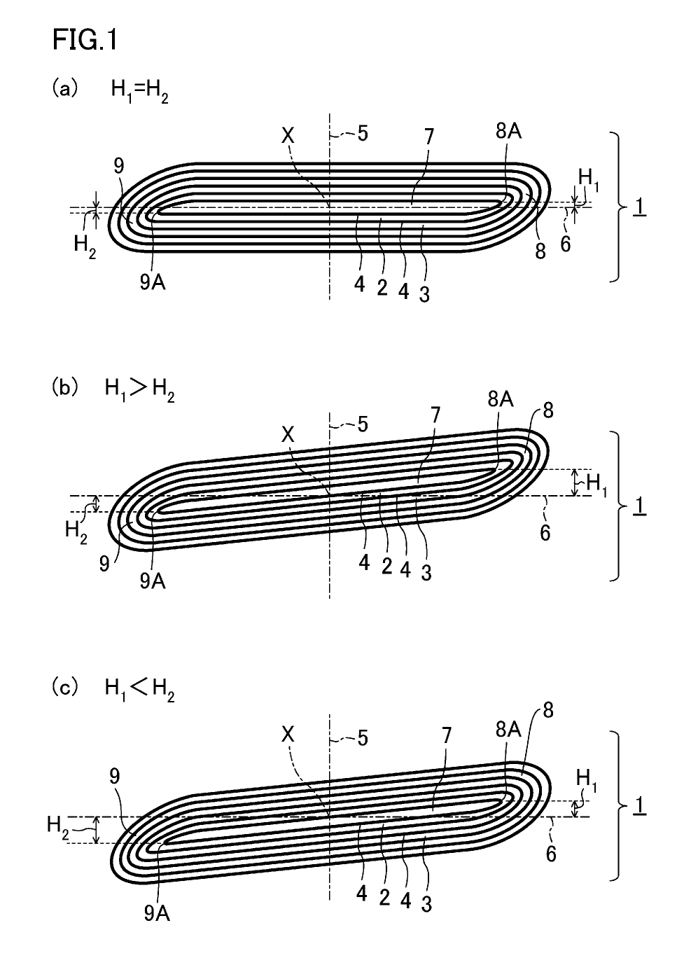

FIGS. 1(a)-1(c) are schematic cross-sectional views of a flat electrode group 1 according to an embodiment of the present invention. The flat electrode group 1 of the present embodiment is formed by winding a negative electrode 2 and a positive electrode 3 with a porous insulator 4 interposed therebetween, and flattening the wound product by pressing, and has a hollow part 7. The negative electrode 2, the positive electrode 3, and the porous insulator 4 are bent (bent portions 8, 9) at longitudinal ends of a lateral cross-section of the flat electrode group 1 (ends in a direction of a long axis). Innermost parts 8A, 9A of the bent portions are not positioned on a major axis 6 of the flat electrode group 1, but are positioned opposite each other relative to the major axis 6.

Specifically, in the electrode group 1 shown in FIG. 1(a), the innermost parts 8A, 9A of the bent portions are symmetric about a point of intersection X of a minor axis 5 and a major axis 6 of the flat electrode group 1 (a substantial center of the lateral cross-section of the flat electrode group 1). A displacement H₁ of the innermost part of the bent portion from the major axis 6 is approximately the same as a displacement H₂ of the innermost part of the bent portion from the major axis 6. In the electrode group 1 shown in FIG. 1(b), the displacement H₁ of the innermost part of the bent portion from the major axis 6 is larger than the displacement H₂ of the innermost part of the bent portion from the major axis 6.

In the electrode group 1 shown in FIG. 1(c), the displacement H₁ of the innermost part of the bent portion from the major axis 6 is smaller than the displacement H₂ of the innermost part of the bent portion from the major axis 6.

Each of the electrode groups shown in FIGS. 1(a)-1(c) can provide the advantages of the present embodiment (described below).

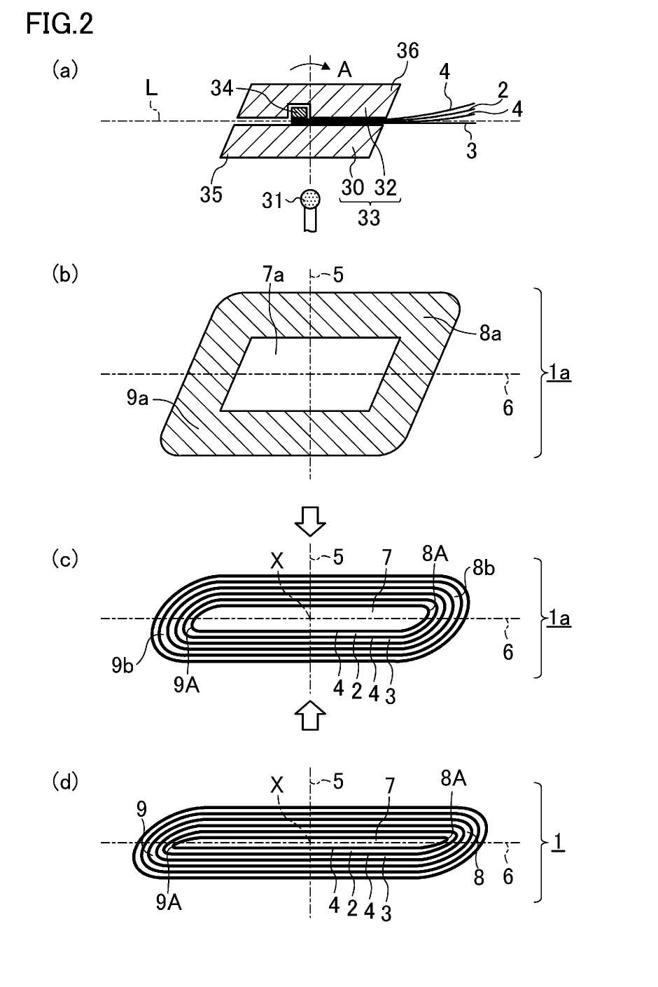

FIGS. 2(a)-2(d) are schematic cross-sectional views sequentially illustrating steps of a method for fabricating the flat electrode group 1 of the present embodiment.

FIG. 2(a) shows an early stage of a step of winding the negative electrode 2 and the positive electrode 3 sandwiching the porous insulator 4 therebetween (a stack) to form the flat electrode group 1. A core 33 around which the stack is wound includes an upper core 32 and a lower core 30. The upper core 32 and the lower core 30 have parallelogram-shaped lateral cross-sections, respectively. The upper core 32 has a corner 36, and the lower core 30 has a corner 35. The upper core 32 has an inner axis 34 to sandwich and hold the stack in the beginning of the winding. The core 33 further includes a pressing cylinder 31 for pressing a wound product (the wound stack). When the core 33 is rotated in a direction A shown in FIG. 2(a), the stack is wound to form an intermediate electrode group 1a shown in FIG. 2(b). The intermediate electrode group 1a has corners 8a, 9a corresponding to the corners 35, 36 of the core 33, and a hollow part 7a. FIG. 2(c) shows pressing of the intermediate electrode group 1a in a direction of the minor axis, and FIG. 2(d) shows a lateral cross-section of the flat electrode group 1 obtained by the pressing.

Specifically, with the corners 35, 36 of the core 33 positioned opposite each other relative to a major axis L of the core 33, the corners 8a, 9a are positioned opposite each other relative to the major axis 6 of the intermediate electrode group 1a. In the step shown in FIG. 2(c), the intermediate electrode group 1a is pressed in the direction of the minor axis. The pressing does not bend the corners 8a, 9a only, but forms bent portions 8b, 9b which include the corners 8a, 9a, respectively, and are bent in a larger area than the corners 8a, 9a. The bent portions 8b, 9b become part of bent portions 8, 9 of the flat electrode group 1 after the pressing, and innermost parts 8A, 9A of the bent portions are positioned opposite each other relative to the major axis 6. With the bent portions 8, 9 formed in this manner, a bend of the corners 8a, 9a or a residual stress associated with the bend can be reduced even when additional bending stress is applied to the bent portions 8, 9 in pressing the intermediate electrode group. This can reduce a width of the crack generated in the electrode mixture layers of the negative electrode 2 and the positive electrode 3, and can reduce the separation of the electrode mixture layers.

In the flat electrode group 1 fabricated in this manner, drop of the electrode mixture layer due to the cracking or separation of the electrode mixture layer can be prevented, thereby preventing the occurrence of an internal short circuit due to the drop of the electrode mixture layer. This can provide the flat secondary battery with high safety.

A method for fabricating the flat electrode group 1 will be described in detail below. The winding step shown in FIG. 2(a) includes a main winding step, and a finishing step. In the main winding step, the stack is sandwiched between the upper core 32 and the lower core 30, and is held by the inner axis 34 and the lower core 30. With a predetermined tension applied to each of the negative electrode 2, the positive electrode 3, and the porous insulator 4, the core 33 is rotated a predetermined number of times in the direction A shown in FIG. 2(a). Thus, the stack is wound.

In the finishing step, the rest of the stack is wound. Under facility-based constraints, it is difficult to wind the rest of the stack at the same tension applied in the main winding step. Thus, in winding a longitudinal end of the stack, the tension applied thereto may become zero, thereby loosening the stack. To reduce the loosening, the stack is sandwiched between the pressing cylinder 31 and the core 33, and the core 33 is rotated at least one time to wind the stack being pressed. Further, while the wound product is pressed by the pressing cylinder 31, an adhesive tape made of polypropylene (this is adhered to a last wound end of the stack) is adhered to an outer peripheral surface of the wound product. When the wound product fabricated in this manner is removed from the core 33, the intermediate electrode group 1a having a parallelogram-shaped lateral cross-section as shown in FIG. 2(b) is obtained. Then, in the pressing step shown in FIG. 2(c), the intermediate electrode group 1a is pressed in the direction of the minor axis to form the flat electrode group 1 shown in FIG. 2(d).

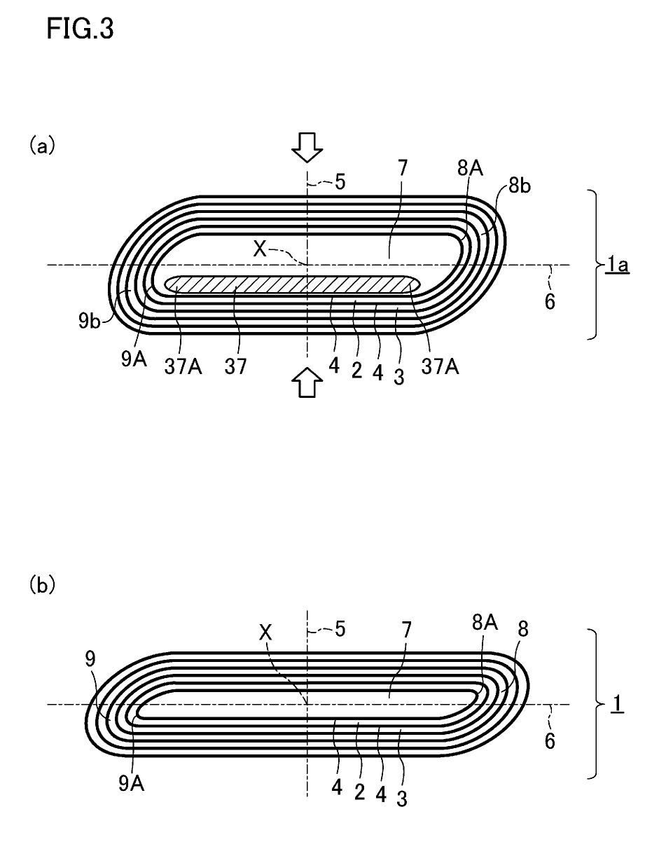

FIG. 3(a) schematically shows pressing of the intermediate electrode group 1a in the direction of the minor axis with a spacer 37 inserted in the hollow part 7a of the intermediate electrode group 1a. The spacer 37 includes curved portions 37A at longitudinal ends, respectively. The spacer 37 is inserted in the hollow part 7a in such a manner that the curved portions 37A are positioned at longitudinal ends of the hollow part 7a of the intermediate electrode group 1a. Thus, as compared with the case where the intermediate electrode group 1a is pressed without the spacer 37 inserted in the hollow part 7a, the hollow part 7 is formed larger (see FIG. 3(b)). Therefore, expansion of the negative electrode 2 and the positive electrode 3 due to charge/discharge (hereinafter merely referred to as “expansion of the negative electrode 2 and the positive electrode 3”) can easily be absorbed by the hollow part 7a, and warpage of the negative electrode 2 and the positive electrode 3 due to charge/discharge can be reduced.

In the present embodiment, the shape of the lateral cross-section of the intermediate electrode group 1a is not limited to the shape shown in FIGS. 1(a)-1(c) as long as the two diagonal corners of the intermediate electrode group 1a are not positioned on the same line perpendicular to the direction in which the intermediate electrode group 1a is pressed. The advantages similar to those of the present embodiment can be obtained in this case. However, when the two corners are positioned on the same line perpendicular to the pressing direction of the intermediate electrode group 1a, the electrode mixture layer may be cracked or separated in pressing the intermediate electrode group 1a, and the internal short circuit may occur.

In other words, the pressing direction of the intermediate electrode group 1a is not limited to the direction of the minor axis of the intermediate electrode group 1a, and the intermediate electrode group 1a can be pressed in any direction except for a direction perpendicular to a line connecting the diagonal corners. The advantages similar to those of the present embodiment can be obtained in this case. However, when the intermediate electrode group 1a is pressed in the direction perpendicular to the line connecting the two diagonal corners, the electrode mixture layer may be cracked or separated in pressing the intermediate electrode group 1a, and the internal short circuit may occur.

In view of easy designing of the core 33, or easy winding, the core 33 having the corners 35, 36 which are symmetric about a center of the core 33 is preferably used in fabricating the electrode group 1. Thus, the electrode group 1 shown in FIG. 1(a) is preferable. However, forming the electrode group 1 of FIG. 1(a) with high yield is not easy. Therefore, even when the core (the core 33 having the corners 35, 36 which are symmetric about the center of the core 33) is used, the electrode group 1 shown in FIG. 1(b) or FIG. 1(c) may be formed. However, the electrode group 1 shown in FIG. 1(b) or FIG. 1(c) can provide substantially the same advantages as those of the electrode group 1 shown in FIG. 1(a) because the innermost parts 8A, 9A of the bend portions are positioned opposite each other relative to the major axis 6.

When the two diagonal corners of the intermediate electrode group 1a are positioned opposite each other relative to the major axis 6 of the intermediate electrode group 1a, the advantages described above can be obtained. Thus, the lateral cross-section of the intermediate electrode group 1a is not necessarily parallelogram-shaped as long as the hollow part 7a of the intermediate electrode group 1a is parallelogram-shaped when viewed in lateral cross-section.

Materials of the flat secondary battery will be described below.

The positive electrode 3 is formed by applying positive electrode mixture paste to one or both of surfaces of a positive electrode current collector, drying the paste, and rolling the obtained product to a predetermined thickness. The positive electrode current collector is made of, for example, foil or nonwoven fabric of aluminum or an aluminum alloy, and has a thickness of 5-30 μm. The positive electrode mixture paste is prepared by mixing and dispersing a positive electrode active material, a conductive agent, and a binder in a dispersion medium using a distributor such as a planetary mixer etc.

The positive electrode active material may be lithium cobaltate or modified lithium cobaltate (e.g., lithium cobaltate containing aluminum or magnesium as a solid solution), lithium nickelate or modified lithium nickelate (e.g., nickel partially substituted with cobalt etc.), lithium manganate or modified lithium manganate, etc.

The conductive agent may be carbon black, such as acetylene black, Ketchen black, channel black, furnace black, lamp black, thermal black, etc., or various type of graphites used alone or in combination.

The binder for the positive electrode may be, for example, poly(vinylidene fluoride) (PVdF), modified PVdF, polytetrafluoroethylene (PTFE), or a rubber particle binder containing an acrylate unit.

The negative electrode 2 is formed by applying negative electrode mixture paste to one or both of surfaces of a negative electrode current collector, drying the paste, and rolling the obtained product to a predetermined thickness. The negative electrode current collector is made of, for example, rolled copper foil, electrolytic copper foil, or nonwoven fabric of copper fiber, and has a thickness of 5-25 μm. The negative electrode mixture paste is prepared by mixing and dispersing a negative electrode active material and a binder (together with a conductive agent and a thickener as needed) in a dispersion medium using a distributor such as a planetary mixer etc.

The negative electrode active material may be, for example, various types of natural graphite, artificial graphite, silicon-based composite materials such as silicide etc., or various types of alloy compositions.

Various types of binders can be used as the binder for the negative electrode, e.g., poly(vinylidene fluoride) (PVdF), and modified PVdF. In view of easy insertion of lithium ions, styrene-butadiene-rubber (SBR) particles or modified SBR particles etc. may preferably be used as the binder for the negative electrode.

The thickener may be a viscous solution, such as poly(ethylene oxide) (PEO), poly(vinyl alcohol) (PVA), etc. In view of easy dispersion of the mixture, and thickening effect, a cellulose-based resin, such as carboxymethylcellulose (CMC), or modified CMC, may preferably be used as the thickener.

The porous insulator 4 is not limited as long as the porous insulator can be durable for use in the flat secondary battery. In particular, the porous insulator is preferably a single layer or multiple layers of a microporous film made of a polyolefin-based resin, such as polyethylene, polypropylene, etc. A microporous insulating layer may be formed on a film, and a thickness of the porous insulator 4 is preferably 10-25 μm.

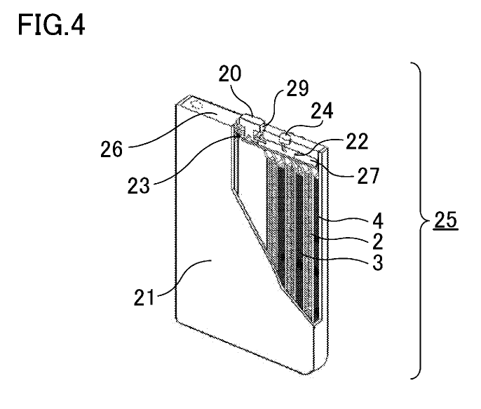

The flat secondary battery of the present embodiment will be described below. FIG. 4 is a perspective view, partially cut away, illustrating a flat secondary battery 25 including the flat electrode group 1 of the present embodiment. The flat secondary battery 25 is fabricated by the following method. The flat electrode group 1, and an insulating frame 27 are placed in a flat battery case 21 having a close end. A negative electrode lead 23 drawn from an upper part of the flat electrode group 1 is connected to a terminal 20 (an insulating gasket 29 is attached to a periphery of the terminal 20), and a positive electrode lead 22 drawn from the upper part of the flat electrode group 1 is connected to a sealing plate 26. The sealing plate 26 is inserted in an opening of the battery case 21, and the sealing plate 26 and the battery case 21 are welded along a rim of the opening of the battery case 21. Thus, the battery case 21 is sealed. A predetermined amount of a nonaqueous electrolytic solution (not shown) is fed into the battery case 21 through a plug hole in the sealing plate 26, and the plug hole is stopped with a plug 24. Thus, the flat secondary battery 25 is fabricated. The above-described fabrication method is merely an example, and the method for fabricating the flat secondary battery 25 is not limited thereto.

Various types of lithium compounds, such as LiPF₆, LiBF₄, etc., may be used as electrolyte salt of the nonaqueous electrolytic solution. As a solvent of the nonaqueous electrolytic solution, ethylene carbonate (EC), dimethyl carbonate (DMC), diethyl carbonate (DEC), or ethyl methyl carbonate (MEC) may be used alone or in combination. To form a good coating on the positive electrode, or to ensure stability in overcharge, vinylene carbonate (VC), cyclohexylbenzene (CHB), or modified cyclohexylbenzene may preferably be used as the solvent of the nonaqueous electrolytic solution.

### EXAMPLES

In the following examples, safety of the flat secondary battery including an electrode group having a lateral cross-section of FIG. 1(a) was evaluated.

### 1. Method for Fabricating Flat Secondary Battery

### Example 1

### (a) Fabrication of Positive Electrode 3

In a dual arm kneader, 100 parts by weight (pbw) of lithium cobaltate (a positive electrode active material), 2 pbw of acetylene black (a conductive agent), 2 pbw of poly(vinylidene fluoride) (a binder), and an appropriate amount of N-methyl-2-pyrrolidone were stirred to obtain positive electrode mixture paste.

Then, the positive electrode material paste was applied to each surface of 15 μm thick aluminum foil (a positive electrode current collector), and dried to form a positive electrode base having a 100 μm thick positive electrode mixture layer on each surface of the aluminum foil.

Then, the positive electrode base was pressed to a total thickness of 165 μm. The pressing reduced the thickness of each of the positive electrode mixture layers to 75 μm. The pressed positive electrode base was cut into a predetermined width to obtain a positive electrode 3.

### (b) Fabrication of Negative Electrode 2

In a dual arm kneader, 100 pbw of artificial graphite (a negative electrode active material), 2.5 pbw of a dispersion of styrene-butadiene rubber particles (a binder, containing 40 wt. % of a solid content) (1 pbw in terms of a solid content of the binder), 1 pbw of carboxymethyl cellulose (a thickener), and an appropriate amount of water were stirred to obtain negative electrode material paste.

The negative electrode material paste was applied to each surface of 10 μm thick copper foil (a negative electrode current collector), and dried to obtain a negative electrode base having a 100 μm thick negative electrode mixture layer on each surface of the copper foil.

Then, the negative electrode base was pressed to a total thickness of 170 μm. The pressing reduced the thickness of each of the negative electrode mixture layers to 80 μm. The pressed negative electrode base was cut into a predetermined width to obtain a negative electrode 2.

### (c) Fabrication of Flat Electrode Group 1

A flat electrode group 1 was fabricated by the method shown in FIGS. 2(a)-2(d).

Specifically, as shown in FIG. 2(a), a stack formed by sandwiching the porous insulator 4 between the negative electrode 2 and the positive electrode 3 was sandwiched between an upper core 32 and a lower core 30, and was held between an inner axis 34 and a lower core 30.

Then, a tension of 1000 gf was applied to the negative electrode 2 and the positive electrode 3, and a tension of 500 gf was applied to the porous insulator 4 to rotate a core 33 in a direction A shown in FIG. 2(a). The stack was wound 7 times in a main winding step, and was wound 3 times in a finishing step while the wound product was pressed by a pressing cylinder 31 at a pressure of 0.06 MPa. Then, a polypropylene adhesive tape was adhered to an outer peripheral surface of the wound product to fix a longitudinal end of the stack to the outer peripheral surface, and then the wound product was removed from the core 33. Thus, an intermediate electrode group 1a shown in FIG. 2(b) was obtained.

Then, as shown in FIG. 2(c), the intermediate electrode group 1a was pressed in a direction of a minor axis thereof. Thus, a flat electrode group 1 shown in FIG. 2(d) was obtained. In the obtained flat electrode group 1, innermost parts 8A, 9A of bent portions were symmetric about a point of intersection X.

### (d) Fabrication of Flat Secondary Battery 25

The obtained flat electrode group 1 and an insulating frame 27 were placed in a flat battery case 21 having a closed end. A negative electrode lead 23 was connected to a terminal 20, and a positive electrode lead 22 was connected to a sealing plate 26. The sealing plate 26 was inserted in an opening of the battery case 21, and the sealing plate 26 and the battery case 21 were welded along a rim of the opening of the battery case 21. Then, a predetermined amount of a nonaqueous electrolytic solution was fed into the battery case 21 through a plug hole, and the plug hole was stopped with a plug 24. Thus, a flat secondary battery 25 was obtained.

### Example 2

A flat secondary battery of Example 2 was fabricated in the same manner as Example 1 except for the tension applied in winding the stack.

Specifically, with the stack of Example 1 held by the core 33, a tension of 800 gf was applied to the negative electrode 2 and the positive electrode 3, and a tension of 200 gf was applied to the porous insulator 4 to rotate the core 33 in the direction A shown in FIG. 2(a). In the flat electrode group 1 obtained in this manner, the innermost parts 8A, 9A of the bent portions were symmetric about the point of intersection X.

### Example 3

A flat secondary battery of Example 3 was fabricated in the same manner as Example 1 except that the intermediate electrode group 1a was pressed by a method shown in FIGS. 3(a)-3(b).

Specifically, as shown in FIG. 3(a), a 0.5 mm thick spacer 37 was inserted in a hollow part 7a of the intermediate electrode group 1a. Curved portions 37A were formed at longitudinal ends of the spacer 37, respectively, and the spacer 37 was inserted in the hollow part 7a of the intermediate electrode group 1a in such a manner that the curved portions 37A are positioned at ends in a direction of a major axis of the hollow part 7a of the intermediate electrode group 1a. Then, with the spacer 37 inserted in the hollow part 7a of the intermediate electrode group 1a, the intermediate electrode group 1a was pressed in the direction of the minor axis thereof. Thus, a flat electrode group 1 shown in FIG. 3(b) was obtained. In the flat electrode group 1, the innermost parts 8A, 9A of the bent portions were symmetric about the point of intersection X.

### Comparative Example 1

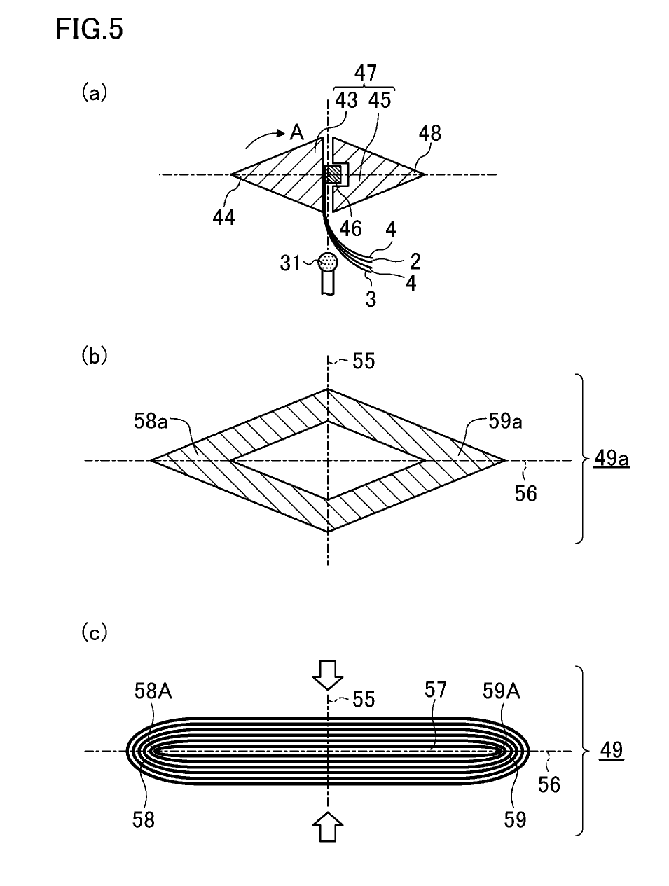

A flat secondary battery of Comparative Example 1 was fabricated in the same manner as Example 1 except that the stack of Example 1 was wound by a method shown in FIGS. 5(a)-5(c).

FIG. 5(a) is a schematic cross-sectional view illustrating an early stage of a step of winding the stack of Example 1. A core 47 for winding the stack includes a left core 43 and a right core 45. The left core 43 and the right core 45 have rhomboid-shaped lateral cross-sections, respectively. The left core 43 has a corner 44, and the right core 45 has a corner 48. The right core 45 includes an inner axis 46 to sandwich and hold stack in the beginning of the winding. The core 47 further includes a pressing cylinder 31 for pressing a wound product. When the core 47 is rotated in a direction A shown in FIG. 5(a), the stack is wound to form an intermediate electrode group 49a having corners 58a, 59a corresponding to the corners 44, 48 as shown in FIG. 5(b). Specifically, the intermediate electrode group 49a has a rhomboid-shaped lateral cross-section. FIG. 5(c) schematically shows a lateral cross-section of a flat electrode group 49 formed by flattening the intermediate electrode group 49a of FIG. 5(b) by pressing. Innermost parts 58A, 59A of bent portions of the flat electrode group 49 are positioned on a major axis 56 of the flat electrode group 49.

### (c) Fabrication of Flat Electrode Group 49

As shown in FIG. 5(a), the stack of Example 1 was sandwiched between the left core 43 and the right core 45, and was held by the inner axis 46 and the right core 45.

A tension of 1000 gf was applied to the negative electrode 2 and the positive electrode 3, and a tension of 500 gf was applied to the porous insulator 4 to rotate the core 47 in the direction A shown in FIG. 5(a). The stack was wound 7 times in the main winding step, and was wound 3 times in the finishing step while the wound product was pressed by the pressing cylinder 31 at a pressure of 0.06 MPa. Then, a polypropylene adhesive tape was adhered to an outer peripheral surface of the wound product to fix a longitudinal end of the stack to the outer peripheral surface, and then the wound product was removed from the core 47. Thus, an intermediate electrode group 49a shown in FIG. 5(b) was obtained.

Then, as shown in FIG. 5(c), the intermediate electrode group 49a was pressed in a direction of a minor axis thereof to obtain a flat electrode group 49. The obtained flat electrode group 49 had bent portions 58, 59 at ends in a direction of the major axis, and innermost parts 58A, 59A of the bent portions were positioned on the major axis 56.

Table 1 shows the details of Examples 1-3 and Comparative Example 1.

TABLE 1

| | Positions of innermost parts | Winding |
|---|---|---|
| | of bent portions | tension |
| Example 1 | Symmetric about point of intersection X | High |
| Example 2 | Symmetric about point of intersection X | Low |
| Example 3 | Symmetric about point of intersection X | High |
| Comparative | On major axis | High |
| Example 1 | | |

### 2. First Evaluation

Flat electrode groups of Examples 1-3 and Comparative Example 1, 100 each, were fabricated, and 60 of the 100 flat electrode groups were used to fabricate flat secondary batteries (60 flat secondary batteries were fabricated), and the remaining 40 flat electrode groups were merely placed in battery cases, respectively. Then, these samples were evaluated in the following manner.

### (a) Whether Battery was Thickened or Not

Thicknesses of the flat secondary batteries were measured immediately after the fabrication, and after 500 charge/discharge cycles, and averages of the two measurements were calculated. Batteries which experienced increase in thickness after the 500 cycles by 20% or higher of the thickness immediately after the fabrication were regarded as thickened batteries.

### (b) Whether Electrode was Warped or Not

Lateral cross-sectional images of the flat secondary batteries were taken at the vertical center thereof immediately after the fabrication, and after the 500 charge/discharge cycles by X-ray computerized tomography (hereinafter abbreviated as CT). The images were visually checked to see whether the electrode was warped or not.

### (c) Whether Electrode Mixture Layer was Cracked, Separated or Not

The flat electrode group placed in the battery case was fixed using a thermosetting resin. Then, the flat electrode group was cut in a direction perpendicular to an axis thereof. The cross-section (a lateral cross-section of the flat electrode group) was observed by a measuring microscope to measure a width of the crack in the electrode mixture layer. The electrode mixture layer in which the width of the crack was smaller than 0.1 mm was regarded as an electrode mixture layer which was not cracked, while the electrode mixture layer in which the width of the crack was 0.1 mm or larger was regarded as a cracked electrode mixture layer. The cross-section was observed by a microscope to see whether the electrode mixture layer was separated or not.

Table 2 shows the results of (a)-(c).

TABLE 2

| | | | Whether the | Whether the |
|---|---|---|---|---|
| | Whether the | Whether the | electrode | electrode |
| | electrode | battery was | mixture layer | mixture layer |
| | was warped | thickened | was cracked | was sepa- |
| | or not | or not | or not | rated or not |
| Example 1 | Not warped | Not thickened | Not cracked | Not separated |
| Example 2 | Not warped | Not thickened | Not cracked | Not separated |
| Example 3 | Not warped | Not thickened | Not cracked | Not separated |
| Compar- | Warped | Thickened | Cracked | Separated |
| ative | | | | |
| Example 1 | | | | |

### 3. Consideration of First Evaluation

The results shown in Table 2 indicate that the negative electrode 2 and the positive electrode 3 of each of Examples 1-3 were not warped, and the increase in thickness of the battery after the 500 charge/discharge cycles was very small. A product (a device in which the flat secondary battery is mounted) was hardly affected.

A presumable reason for the results is as follows. The corners 8a, 9a of the intermediate electrode group 1a are symmetric about the point of intersection of the minor axis 5 and the major axis 6 of the intermediate electrode group 1a. When the intermediate electrode group 1a is pressed in the direction of the minor axis, the generated stress is distributed to form gently curved bent portions 8, 9 in the flat electrode group 1. Thus, when placed in the battery case 21, the flat electrode group 1 is deformed to return to the shape before the pressing, thereby approaching the inner side surface of the battery case 21. As a result, the hollow part 7 is formed in the flat electrode group 1. Even when the negative electrode 2 and the positive electrode 3 expand through repetitive charge/discharge, the expansion of the negative electrode 2 and the positive electrode 3 is absorbed by the sufficiently large hollow part 7 formed in the flat electrode group 1. This can reduce the occurrence of the warpage of the negative electrode 2 and the positive electrode 3, and can reduce the increase in thickness of the battery.

Although not shown in Table 2, the increase in thickness of the battery was smaller in Examples 2 and 3 than in Example 1. A presumable reason why the increase in battery thickness was smaller in Example 2 is that the tension in winding the stack was small. When the tension in winding the stack is small, the stress generated during the winding is reduced, thereby a reducing residual stress in the electrodes at the bent portions 8, 9. Thus, when a volume of the flat electrode group 1 is increased by the expansion of the negative electrode 2 and the positive electrode 3 through the charge/discharge, the current collectors extend in response to the increase in volume of the flat electrode group 1. This can reduce the occurrence of the warpage of the negative electrode 2 and the positive electrode 3, and can reduce the increase in thickness of the battery.

A presumable reason why the increase in battery thickness was smaller in Example 3 is that the spacer 37 was used in pressing the intermediate electrode group 1a. When the intermediate electrode group 1a is pressed with the spacer 37 inserted in the hollow part 7a, the bent portions 8, 9 formed in the flat electrode group 1 are gently curved as compared with the case where the intermediate electrode group 1a is pressed without using the spacer 37. Thus, the flat electrode group 1 inserted in the battery case 21 significantly returns to the original shape, and the hollow part 7 becomes large. The large hollow part 7 can easily absorb the expansion of the negative electrode 2 and the positive electrode 3. This can further reduce the occurrence of the warpage of the negative electrode 2 and the positive electrode 3, and can reduce the increase in thickness of the battery.

As shown in Table 2, the width of the crack in the electrode mixture layer at the innermost parts 8A, 9A of the bent portions was very small in each of Examples 1-3. The separation of the electrode mixture layer at the innermost parts 8A, 9A of the bent portions was hardly observed, and the product was hardly affected.

A presumable reason for the results is as follows. Since the corners 35, 36 of the core 33 are symmetric about a center of the lateral cross-section of the core 33, the corners 8a, 9a of the intermediate electrode group 1a are symmetric about the point of intersection of the minor axis 5 and the major axis 6 of the intermediate electrode group 1a. Pressing the intermediate electrode group 1a in the direction of the minor axis does not bend the corners 8a, 9a only, but forms bent portions 8b, 9b which include the corners 8a, 9a, respectively, and are bent in a larger area than the corners 8a, 9a. Thus, as shown in FIG. 2(d), the innermost parts 8A, 9A of the bent portions are symmetric about the point of intersection X.

With the innermost parts 8A, 9A of the bent portions formed in this way, a bend of the corners 8a, 9a or a residual stress associated with the bend can be reduced even when additional bending stress is applied to the bent portions 8, 9 in pressing the intermediate electrode group. This can presumably reduce the width of the crack in the electrode mixture layer, and can reduce the separation of the electrode mixture layer.

The negative electrode 2 and the positive electrode 3 of Comparative Example 1 were warped, and the battery was thickened. Specifically, the battery was thickened by 0.6 mm. It is presumed that the increase in thickness significantly affects the product, e.g., the flat secondary battery may be detached from the product.

A presumable reason for the results is as follows. In the step shown in FIG. 5(a), the stack was wound without partially reducing the tension. Thus, the innermost parts 58A, 59A of the bent portions of the flat electrode group 49 were not easily deformed. Therefore, the flat electrode group 49 was hardly returned to the original shape after inserted in the battery case 21, and the hollow part 57 was smaller than those of Examples 1-3. It was difficult to absorb the expansion of the negative electrode 2 and the positive electrode 3 by the hollow part 57, and the negative electrode 2 and the positive electrode 3 were warped. Due to the warpage, the flat electrode group 1 significantly expanded radially outward, and the battery was significantly thickened.

In the innermost parts 58A, 59A of the bent portions, the electrode mixture layer was cracked, and the crack had a width of 1.1 mm. Microscopic foreign matters may easily enter the crack having such a width. Thus, in Comparative Example 1, the internal short circuit is more likely to occur than in Examples 1-3, and overheat easily occurs. The separation of the electrode mixture layer not only reduces quality due to reduction in capacity, but also exposes the current collector when the separated mixture layer is dropped. Thus, the internal short circuit is likely to occur.

A presumable reason for the results is as follows. In Comparative Example 1, the corners 58a, 59a of the intermediate electrode group 49a are formed based on the corners 44, 48 of the core 47. Thus, significant residual stress or distortion in the winding step remains near the corners 58a, 59a. It is presumed that the cracking or separation of the electrode mixture layer was caused by pressing this intermediate electrode group 49a.

### 4. Second Evaluation

Among the flat secondary batteries which experienced the 500 charge/discharge cycles, 30 batteries were used. Ten of the 30 batteries were used to perform a drop test, another 10 batteries were used to perform a crush test with a round rod, and the remaining 10 batteries were used to perform a heat test at 150° C.

### (d) Drop Test

The flat secondary batteries were charged at a current of 2 A to an upper limit voltage of 4.2 V for 2 hours. Then, the batteries were dropped from a height of 1.5 m on a concrete floor. The drop test was performed 10 times on each of 6 surfaces of each flat secondary battery. Temperatures of heat generated by the batteries were measured at a room temperature of 25° C. to obtain an average of the temperatures.

(e) Crush Test with Round Rod

The flat secondary batteries were charged at a current of 2 A to an upper limit voltage of 4.2 V for 2 hours. Then, each of the batteries was laid down, and a round rod (10 mm in diameter), which was set perpendicular to the length of the battery, was dropped from a predetermined height to crush the battery. Temperatures of heat generated by the batteries were measured at a room temperature of 25° C. to obtain an average of the temperatures.

### (f) Heat Test at 150° C.

The flat secondary batteries were charged at a current of 2 A to an upper limit voltage of 4.2 V for 2 hours. Then, the batteries were placed in a thermostat, and a temperature in the thermostat was raised from a room temperature to 150° C. at a rate of 5° C./minute. Temperatures of heat generated by the batteries were measured to obtain an average of the temperatures.

TABLE 3

| | | Crush test with | Heat test at |
|---|---|---|---|
| | Drop test | round rod | 150° C. |
| | Temperature of | Temperature of | Temperature of |
| | generated | generated | generated |
| | heat (° C.) | heat (° C.) | heat (° C.) |
| Example 1 | 25° C. | 25° C. | 150° C. |
| | (no heat | (no heat | (no heat |
| | generation) | generation) | generation) |
| Example 2 | 25° C. | 25° C. | 150° C. |
| | (no heat | (no heat | (no heat |
| | generation) | generation) | generation) |
| Example 3 | 25° C. | 25° C. | 150° C. |
| | (no heat | (no heat | (no heat |
| | generation) | generation) | generation) |
| Comparative | 50° C. | 120° C. | 170° C. |
| Example 1 | (heat generated) | (heat generated) | (heat generated) |

5. Consideration of Second Evaluation The result shown in Table 3 indicate that Examples 1-3 did not show any defects in the drop test, the crush test with the round rod, and the heat test at 150° C. A presumable reason for the results is that the warpage of the positive electrode 3 and the negative electrode 2 was reduced, and the occurrence of the internal short circuit due to the warpage of the electrode was reduced.

When the batteries of Comparative Example 1 were disassembled and checked after the 500 charge/discharge cycles, defects such as deposition of lithium, break of the electrode, buckling of the electrode, and drop of the electrode mixture layer, etc. were observed. In each of the drop test, the crush test with the round rod, and the heat test at 150° C., the temperature of generated heat was high. A presumable reason for the heat generation is that the internal short circuit was caused due to the drop of the electrode mixture layer, the break of the electrode, or the buckling of the electrode in the winding step.

The above results clarified that forming the intermediate electrode group 1a having the parallelogram-shaped lateral cross-section by winding the stack can reduce the cracking or separation of the electrode mixture layer at the innermost parts 8A, 9A of the bent portions in pressing the intermediate electrode group 1a.

In the winding step shown in FIG. 2(a), the corners 35, 36 of the core 33 are symmetric about the center of the lateral cross-section of the core 33. Thus, the corners 8a, 9a of the intermediate electrode group 1a shown in FIG. 2(b) are symmetric about the point of intersection X of the minor axis 5 and the major axis 6 of the intermediate electrode group 1a.

In the pressing step shown in FIG. 2(c), the intermediate electrode group 1a is pressed in the direction of the minor axis. The pressing does not bend the corners 8a, 9a only, but forms the bent portions 8b, 9b which include the corners 8a, 9a, respectively, and are bent in a larger area than the corners 8a, 9a. Thus, the innermost parts 8A, 9A of the bent portions of the flat electrode group 1 are symmetric about the point of intersection X.

With the innermost parts 8A, 9A of the bent portions are formed in this manner, a bend of the corners 8a, 9a or a residual stress associated with the bend can be reduced even when additional bending stress is applied to the bent portion 8, 9 in pressing the intermediate electrode group. This can presumably reduce the cracking of the electrode mixture layers of the negative electrode 2 and the positive electrode 3, and can reduce the separation of the electrode mixture layers.

When the core 47 having the rhomboid-shaped lateral cross-section which is laterally symmetric with respect to the minor axis 55, and is longitudinally symmetric with respect to the major axis 6 as shown in FIGS. 5(a)-5(c) is used, the innermost parts 58A, 59A of the bent portions are formed based on the corners 44, 48 of the core 47. Thus, the innermost parts 58A, 59A of the bent portions presumably have a residual stress or distortion derived from the winding. It is presumed that the cracking or separation of the negative electrode 2 and the positive electrode 3 is more likely to occur when the parts are pressed.

In Examples 1-3, the innermost parts 8A, 9A of the bent portions which are symmetric about the point of intersection X have been described. However, the positional relationship between the innermost parts 8A, 9A of the bent portions is not limited to those of Examples 1-3. For example, as shown in FIG. 1(b) or FIG. 1(c), the innermost parts 8A, 9A of the bent portions which are positioned opposite each other relative to the major axis 6 can provide the advantages similar to those of Examples 1-3.

In FIGS. 1(a)-1(c), FIGS. 2(b)-2(d), FIGS. 3(a)-3(b), and FIGS. 5(b)-5(c), the lateral cross-section of the flat electrode group is schematically illustrated to avoid complication of the drawings.

### INDUSTRIAL APPLICABILITY

According to the present invention, innermost parts of bent portions are positioned opposite each other relative to a major axis of a flat electrode group, and separation or drop of an electrode mixture layer during pressing can be reduced. This can provide can provide a highly safe flat secondary battery. Thus, the battery of the present invention is useful as a battery mounted in devices which requires safety (e.g., portable devices or vehicles).

### DESCRIPTION OF REFERENCE CHARACTERS

1 Electrode group
1a Intermediate electrode group
2 Negative electrode
3 Positive electrode
4 Porous insulator
5 Minor axis
6 Major axis
7 Hollow part
8, 9 Bent portion
8A, 9A Innermost part of bent portion
8a, 9a Corner
8b, 9b Bent portion
25 Flat secondary battery
30 Lower core
31 Cylinder
32 Upper core
33 Core
34 Inner axis
35 Corner
36 Corner
37 Spacer

1. An electrode group for a flat secondary battery formed by winding a positive electrode and a negative electrode with a porous insulator interposed therebetween, and flattening the wound electrode group by pressing, wherein
bent portions are provided at ends of the electrode group in a direction of a long axis thereof, respectively, and
parts of the bent portions at the innermost of the electrode group are positioned opposite each other relative to a center line which passes a midpoint of the electrode group in a direction of a thickness thereof, and extends in the direction of the long axis.

2. The electrode group for the flat secondary battery of claim 1, wherein
the parts of the bent portions at the innermost of the electrode group are symmetric about a point on the center line.

3. A method for fabricating an electrode group for a flat secondary battery, the method comprising:
winding a positive electrode and a negative electrode with a porous insulator interposed therebetween to form an intermediate electrode group having a parallelogram-shaped lateral cross-section; and
pressing the intermediate electrode group to form a flat electrode group, wherein
bent portions are formed at ends of the electrode group in a direction of a long axis thereof, respectively, by pressing the intermediate electrode group, and
parts of the bent portions at the innermost of the electrode group are positioned opposite each other relative to a center line which passes a midpoint of the electrode group in a direction of a thickness thereof, and extends in the direction of the long axis.

4. The method of claim 3, wherein
the intermediate electrode group is pressed with a spacer having curved portions at longitudinal ends thereof inserted in a hollow part of the intermediate electrode group.

5. A flat secondary battery comprising:
the electrode group for the flat secondary battery of claim 1, and an electrolytic solution placed in a battery case.
